(19) United States
(12) Patent Application Publication
(10) Pub. No.: US 2014/0326112 A1
(43) Pub. Date: Nov. 6, 2014

(54) PNEUMATIC RATCHET WRENCH

(71) Applicant: Basso Industry Corp., Taichung City (TW)

(72) Inventors: Cheng-Wei LAI, Taichung City (TW); San-Yih SU, Taichung City (TW)

(73) Assignee: Basso Industry Corp., Taichung City (TW)

(21) Appl. No.: 14/226,329

(22) Filed: Mar. 26, 2014

(30) Foreign Application Priority Data
May 2, 2013 (TW) 102208132

(51) Int. Cl. B25B 21/00

(52) U.S. Cl. CPC B25B 21/004
USPC 81/464

(57) ABSTRACT

A pneumatic ratchet wrench includes a transmission mechanism (200) having a transmission shaft (210) with a driving end (211) and a transmitting end (212) extended from the driving end (211), a clutch seat (240) and two hammer rings (250), a pneumatic motor (300) and a ratchet joint (400). Two opposite anvils (220) are formed on the driving end (211), and an eccentric shaft (230) is axially protruded from the transmitting end (212). The clutch seat (240) is rotably sheathed on the driving end (211) and has two parallel limit pins 241, and the hammer rings (250) are installed to the limit pins (241) and corresponsive to the anvils (220) respectively. The pneumatic motor (300) is coupled to the clutch seat (240) for driving and rotating the clutch seat (240). The ratchet joint (400) is coupled to the eccentric shaft (230) and driven by the transmission shaft (210).

### FIELD OF THE INVENTION

The present invention relates to a pneumatic ratchet wrench, and more particularly to the pneumatic ratchet wrench with dual hammer rings.

### BACKGROUND OF THE INVENTION

A pneumatic wrench is a common tool for mechanical maintenance jobs and generally used to install or remove a screw quickly. In general, the pneumatic wrench rotates a screw through the rotation of a transmission shaft by using a pneumatic motor. The torque applied during the process of rotating the screw (for installation or removal) is not large, but a relatively greater torque is required to secure the screw. Similarly, a relatively large torque is required to loosen the screw.

Therefore, most pneumatic wrenches come with a reduction gear installed at an output shaft of the pneumatic motor to enhance the torque. However, users may continue outputting the torque from the reduction gear after the screw has been secured tightly, and thus a reaction force of the tool may be exerted on the users' hands easily.

In U.S. Pat. No. 8,261,849, a hammer is installed to an output shaft of a pneumatic motor and provided for pounding on a side of a transmission shaft, so that the transmission shaft can output a greater torque. However, such pneumatic wrench has the following drawbacks. There is only one hammer ring, so that the forces exerted on the transmission shaft may be uneven, and the transmission shaft may be deformed easily, or the service life of the transmission shaft may be shortened. Furthermore, a relatively greater vibration may be produced during the hammering process due to the uneven forces exerted on the transmission shaft.

In view of the aforementioned drawbacks of the conventional pneumatic ratchet wrench, the inventor of the present invention based on years of experience in the related industry to conduct extensive researches and experiments, and finally designed a feasible solution to overcome the drawbacks of the prior art.

### SUMMARY OF THE INVENTION

Therefore, it is a primary objective of the present invention to overcome the drawbacks of the prior art by providing a pneumatic ratchet wrench with dual hammer rings.

To achieve the aforementioned objectives, the present invention provides a pneumatic ratchet wrench comprising a transmission mechanism, a pneumatic motor and a ratchet joint. The transmission mechanism further comprises a transmission shaft, a clutch seat and two hammer rings, wherein the transmission shaft has a driving end and a transmitting end extended from the driving end. Two anvils are formed on the outer circumferential surface of the driving end and disposed opposite to each other, and the transmitting end has an eccentric shaft axially protruded from the transmitting end, and the clutch seat is rotably sheathed on the driving end, and the clutch seat has two limit pins installed therein and arranged parallel to each other, and each hammer ring is pivotally coupled to each respective limit pin and configured to be corresponsive to each respective anvil. The pneumatic motor is coupled to the clutch seat for driving the clutch seat to rotate. The ratchet joint is coupled to the eccentric shaft and driven by the transmission shaft.

Preferably, the anvil of the pneumatic ratchet wrench has a striking surface formed on a side of the anvil, and each hammer ring is configured to be corresponsive to each respective striking surface and provided for hammering the striking surface.

Preferably, each hammer ring of the pneumatic ratchet wrench is movably sheathed on the driving end, and each hammer ring has a striking block formed at an inner rim of the hammer ring for pounding on the striking surface.

Preferably, each hammer ring of the pneumatic ratchet wrench is movably sheathed on the driving end, and each hammer ring has a striking block formed at an inner rim of the hammer ring for pounding on the anvil.

Preferably, the striking block of the pneumatic ratchet wrench pushes against the anvil and drives the transmission shaft to rotate axially.

Preferably, each hammer ring of the pneumatic ratchet wrench has a pivot groove and a limit groove formed at an outer rim of the hammer ring, and one of the limit pins is pivotally coupled to the pivot groove, and the other limit pin is contained and installed in the limit groove.

Preferably, the hammer ring of the pneumatic ratchet wrench pushes against the anvil and drives the transmission shaft to rotate axially.

Preferably, the pneumatic ratchet wrench further comprises a handle case, and the ratchet joint is installed at an end of the handle case, and the transmission mechanism and the pneumatic motor are contained and installed in the handle case.

The pneumatic ratchet wrench of the present invention can reduce the vibration produced during the hammering process by using the two anvils of the transmission shaft for a separation and applying the forces of two hammer rings on both sides. In addition, the two hammer rings strike at the transmission shaft uniformly, so that the transmission shaft is not damaged or deformed easily, and the service life of the transmission shaft may be extended.

### BRIEF DESCRIPTION OF THE DRAWINGS

FIG. 1 is an exploded view of a pneumatic ratchet wrench in accordance with a preferred embodiment of the present invention;

FIG. 2 is an exploded view of a transmission mechanism of a pneumatic ratchet wrench in accordance with a preferred embodiment of the present invention;

FIG. 3 is a partial longitudinal sectional view of a pneumatic ratchet wrench in accordance with a preferred embodiment of the present invention;

FIG. 4 is a schematic view of the operation of a transmission mechanism of a pneumatic ratchet wrench in accordance with a preferred embodiment of the present invention; and

FIG. 5 is another schematic view of the operation of a transmission mechanism of a pneumatic ratchet wrench in accordance with a preferred embodiment of the present invention.

### DESCRIPTION OF THE PREFERRED EMBODIMENTS

The technical contents of the present invention will become apparent with the detailed description of preferred embodiments accompanied with the illustration of related drawings as follows. It is noteworthy that same numerals are used for representing same respective elements in the drawings.

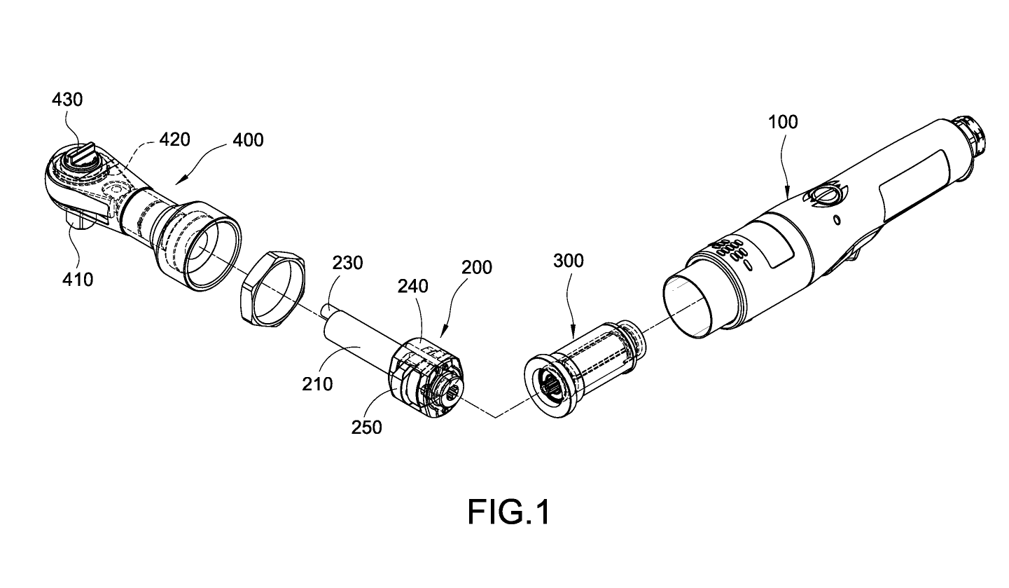

With reference to FIG. 1 for an exploded view of a pneumatic ratchet wrench in accordance with a preferred embodiment of the present invention, the pneumatic ratchet wrench is connected to a positive-pressure air supply and comprises a handle case 100, a transmission mechanism 200, a pneumatic motor 300 and a ratchet joint 400.

The handle case 100 is substantially in a hollow cylindrical shape, and the transmission mechanism 200 and the pneumatic motor 300 are contained and installed in the handle case 100. One end of the handle case 100 is provided for connecting a positive-pressure air supply (not shown in the figure), and the other end is provided for installing the ratchet joint 400.

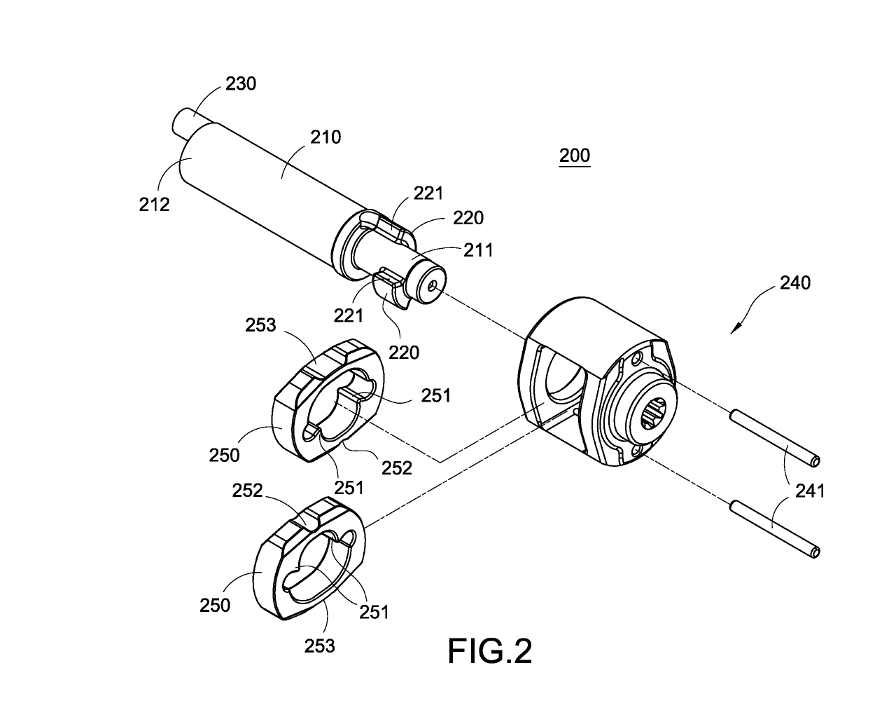

In FIGS. 1 to 3, the transmission mechanism 200 comprises a transmission shaft 210, a clutch seat 240 and two hammer rings 250. Both ends of the transmission shaft 210 are a driving end 211 and a transmitting end 212 extended from the driving end 211 respectively, and the driving end 211 has two anvils 220 formed on an outer circumferential surface of the driving end 211 and disposed opposite to each other, and an eccentric shaft 230 is axially protruded from the transmitting end 212. Each anvil 220 has two striking surfaces 221 formed on both sides of the anvil 220 and disposed opposite to each other, and the striking surface 221 is disposed around the periphery of the transmission shaft 210.

The clutch seat 240 is substantially a hollow cylinder rotably sheathed on the driving end 211 of the transmission shaft 210, and the clutch seat 240 includes two parallel limit pins 241 disposed therein. A striking block 251 is formed at an inner rim of each hammer ring 250 and provided for pounding on striking surface 221, and a pivot groove 252 and a limit groove 253 are formed on an outer rim of the hammer ring 250. The two hammer rings 250 are contained and installed in the clutch seat 240 and configured to be corresponsive to one of the anvils 220 and stacked and sheathed on the driving end 211. Two hammer rings 250 are respectively and pivotally coupled to the limit pins 241, and preferably each hammer ring 250 is pivotally installed in one of the limit pins 241 through the pivot groove 252 and the other limit pin 241 is contained and installed in the limit groove 253, so that both sides of the limit pin 241 corresponding to the limit grooves 253 limit the pivoting stroke of the hammer ring 250.

The pneumatic motor 300 is interconnected with the positive-pressure air supply and driven by the positive-pressure air supply for its operation, and the pneumatic motor 300 is coupled to the clutch seat 240 for driving the clutch seat 240 to rotate.

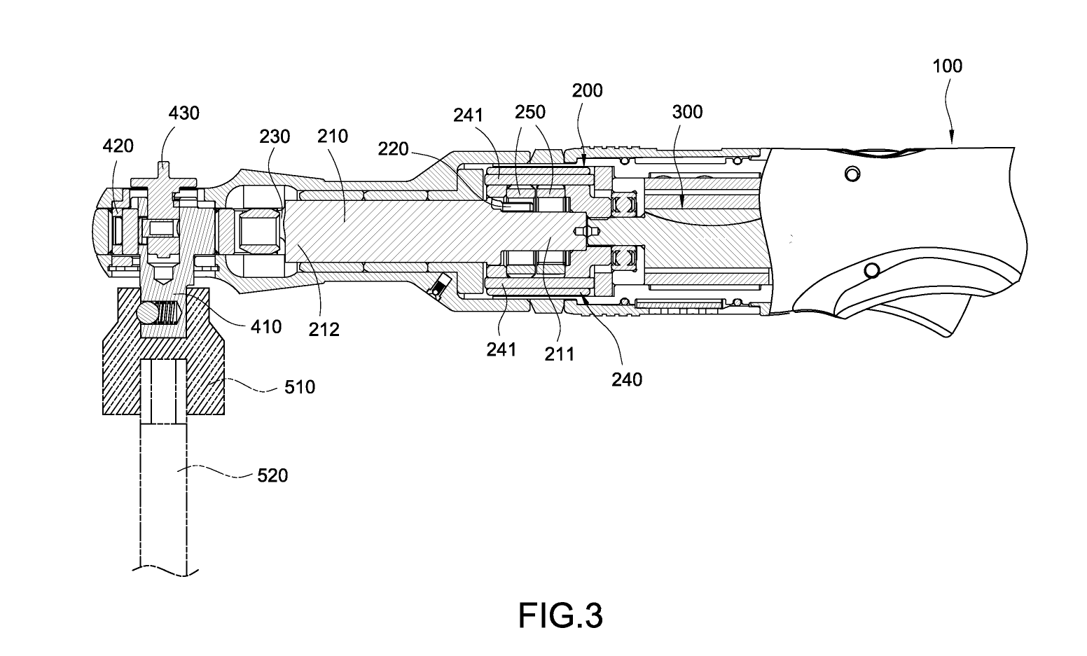

In FIGS. 1 and 3, the ratchet joint 400 is coupled to the eccentric shaft 230 and includes a connecting shaft 410, a ratchet 420 and a directional knob 430. The connecting shaft 410 is coupled to a socket 510 for securing or removing a screw 520. The ratchet 420 is disposed between the connecting shaft 410 and the eccentric shaft 230, and the eccentric shaft 230 rotates the ratchet 420 reciprocally, and the ratchet 420 can intermittently rotate the connecting shaft 410 in one direction for an axial rotation (and the rotation of the ratchet 420 in the other direction is an idle rotation which will not drive the connecting shaft 410 to rotate). The directional knob 430 is provided for setting the rotating direction of the ratchet 420 for its reciprocal rotation.

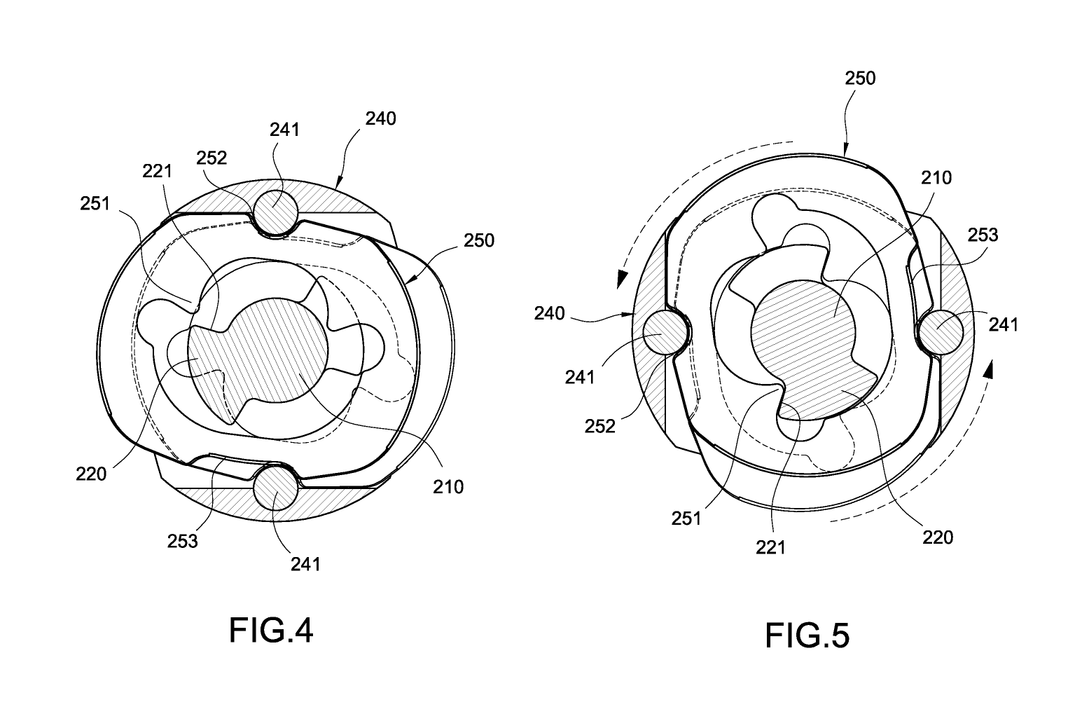

In FIGS. 3 to 5, the operation of the pneumatic ratchet wrench of the present invention is mainly divided into the following two modes:

1. In the process of screwing the screw 520 inwardly or outwardly, the torque exerted on the transmission mechanism 200 is relatively small, so that the clutch seat 240 is driven to rotate by the pneumatic motor 300, and each hammer ring 250 pushes against the corresponding striking surface 221 of the anvil 220 by a striking block 251 to push the transmission shaft 210 to rotate, thereby intermittently driving the connecting shaft 410 of the ratchet joint 400 in a single direction to make the connecting shaft 410 rotate axially. (Since the two anvils 220 of each hammer ring 250 are symmetrical, therefore when the clutch seat 240 is rotated in an opposite direction, the relative operation of the hammer ring 250 and the anvil 220 is the same as described above).

2. In the process of loosening or securing a screw 520, the torque exerted on the transmission mechanism 200 is relative greater. When the torque exceeds a default torque, the pneumatic motor 300 no longer has sufficient power to drive the transmission shaft 210, but the clutch seat 240 is still rotating, so that the striking block 251 is pushed by the anvil 220 to pivotally rotate the hammer ring 250 with respect to the limit pin 241, so that the striking block 251 is separated from the anvil 220. At the moment when the striking block 251 is separated from the anvil 220, the clutch seat 240 accelerates its rotation. After the clutch seat 240 has rotated for a round, the striking block 251 will strike the striking surface 221 of the anvil 220. The striking block 251 strikes the anvil 220 to produce a relatively greater momentum to loosen or secure the screw 520. (Since the two anvils 220 of each hammer ring 250 are symmetrical, therefore when the clutch seat 240 is rotated in an opposite direction, the relative operation of the hammer ring 250 and the anvil 220 is the same as described above.)

The pneumatic ratchet wrench of the present invention has two hammer rings 250, and the transmission shaft 210 operating with the two hammer rings 250 has two anvils 220 disposed opposite to each other, and the two hammer rings 250 strike at two positions on the circumferential surface of the transmission shaft 210 respectively, so that forces exerted on the transmission shaft 210 is even, and the transmission shaft 210 will not be deviated or twisted.

While the invention has been described by means of specific embodiments, numerous modifications and variations could be made thereto by those skilled in the art without departing from the scope and spirit of the invention set forth in the claims.

What is claimed is:

1. A pneumatic ratchet wrench, comprising:
a transmission mechanism (200), further comprising a transmission shaft (210), a clutch seat (240) and two hammer rings (250), and the transmission shaft (210) having a driving end (211) and a transmitting end (212) extended from the driving end (211), and the driving end (211) having two anvils (220) formed on an outer circumferential surface of the driving end (211) and disposed opposite to each other, and the transmitting end (212) has an eccentric shaft (230) axially protruded from the transmitting end (212), and the clutch seat (240) being rotably sheathed on the driving end (211), and the clutch seat (240) having two limit pins (241) parallel to each other, and each hammer ring (250) being pivotally installed to the respective limit pin (241) and configured to be corresponsive to each respective anvil (220);
a pneumatic motor 300, coupled to the clutch seat (240) and provided for driving and rotating the clutch seat (240); and
a ratchet joint (400), coupled to the eccentric shaft (230), and driven by the transmission shaft (210).

2. The pneumatic ratchet wrench of claim 1, wherein the anvil (220) has a striking surface (221) formed on a side of the anvil (220), and each hammer ring (250) is configured to be corresponsive to each respective striking surface (221) and provided for hammering the striking surface (221).

3. The pneumatic ratchet wrench of claim 2, wherein each hammer ring (250) is movably sheathed on the driving end (211), and each hammer ring (250) has a striking block (251) formed at an inner rim of the hammer ring (250) for pounding on the striking surface (221).

4. The pneumatic ratchet wrench of claim 1, wherein each hammer ring (250) is movably sheathed on the driving end (211), and each hammer ring (250) has a striking block (251) formed at an inner rim of the hammer ring (250) and provided for pounding on the anvil (220).

5. The pneumatic ratchet wrench of claim 4, wherein the striking block (251) pushes against the anvil (220) and drives the transmission shaft (210) to rotate axially.

6. The pneumatic ratchet wrench of claim 1, wherein each hammer ring (250) has a pivot groove (252) and a limit groove (253) formed at an outer rim of the hammer ring (250), and one of the limit pins (241) is pivotally coupled to the pivot groove (252), and the other limit pin (241) is contained and installed in the limit groove (253).

7. The pneumatic ratchet wrench of claim 1, wherein the hammer ring (250) pushes against the anvil (220) and drives the transmission shaft (210) to rotate axially.

8. The pneumatic ratchet wrench of claim 1, further comprising a handle case (100), and the ratchet joint (400) being disposed at an end of the handle case (100), and the transmission mechanism (200) 1 and the pneumatic motor (300) being contained and installed in the handle case (100).
